(19) United States
(12) Patent Application Publication
(10) Pub. No.: US 2002/0169655 A1
(43) Pub. Date: Nov. 14, 2002

(54) Global campaign optimization with promotion-specific customer segmentation

(76) Inventors: Dirk M. Beyer, Mountain View, CA (US); Cipriano A. Santos, Mountain View, CA (US); Bilal Iqbal, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/853,658

(22) Filed: May 10, 2001

(51) Int. Cl. G06F 17/60

(52) U.S. Cl. 705/10

(57) ABSTRACT

A method and system thereof for segmenting customers by promotion. Each customer in a test group of customers is segmented into a segment in a plurality of segments for each promotion in a plurality of promotions. Accordingly, for each promotion, there is a corresponding set of segments, each segment representing a first respective group of customers having a certain response to the promotion. The customers are then separated into a plurality of meta-segments, wherein each meta-segment represents a second respective group of customers having a certain response to all of the promotions in the plurality of promotions. The use of meta-segments facilitates the design and optimization of an advertising campaign by maintaining a desirable level of detail while reducing the number of input parameters.

### TECHNICAL FIELD

The present invention relates to a method and system for processing data. More specifically, the present invention pertains to a method and system for processing information used in the design of a promotional (e.g., advertising) campaign.

### BACKGROUND ART

An information record typically contains a multiplicity of variables (or attributes and/or fields), with information preferably provided for each variable in the record. Based on the information in the record, the record can be classified (segmented) into one or more of a number of different categories.

For example, the variables in a customer record might include the customer's level of education, income, address, hobbies and interests, and recent purchases. The customer is commonly requested to provide this type of information on product registration cards or warranty cards provided to the customer when he or she purchases a product. Additionally, this type of information is also frequently requested from customers when they shop on-line (e.g., over the Internet). Certain information can also be obtained from the customer's computer upon connecting to a Web site over the Internet. Furthermore, test marketing (e.g., a marketing survey) is also performed in order to deliberately gather such information.

The information obtained from customers is often used by marketing professionals who design advertising (promotional) campaigns. In simple terms, an advertising campaign may have different advertising promotions that can be offered to different customers. These advertising promotions may include an offer for sale of a product, a coupon for a product, a rebate on a product, etc. The marketing professional is faced with deciding which promotion should be offered to which customers.

Segmentation methods are used to segment (classify) customer information in order to put the information into a form more meaningful to the marketing professional. Commonly used segmentation methods include CART (Classification and Regression Tree), k-means, k-harmonic means, and clustering. Typically, a segmentation method is used to group customers into segments that, to a satisfactory degree, represent customers with similar responses to a particular promotion. More specifically, a set of attributes, characteristics or rules can be defined for each segment that generally describe the customers represented by the segment.

Once the segments are defined, they can be used to predict the behavior of new customers as well as existing customers (those customers that provided the information used by the segmentation method). The new customers can be represented using existing segments by correlating their attributes to the attributes that were used to define each of the segments. The segmented information can then be used by marketing professionals to design a more effective advertising campaign that takes into account which promotion(s) should be offered to which segment(s).

In order to design an effective advertising campaign, decisions have to be made at the segment and promotion level (e.g., which promotion to offer to which segment), but the campaign is also subject to business objectives and other constraints that are, in general, defined at a higher, more global level. For example, a desired level of profitability, a desired rate of acceptance for each promotion, and a budget limiting costs that can be incurred may have to be considered. Thus, the marketing professional is faced with the difficult and complex task of integrating and balancing lower level objectives with the higher level objectives.

A number of prior art approaches have been developed to assist the marketing professional, but they each have their shortcomings. In one prior at approach (“promotion-centric segmentation”), customers are grouped based on which promotion(s) they respond to best, using some criterion specified by the marketing professional. However, this approach only allows optimization of the criterion used for customer segmentation, and shares the problems described above; that is, it is still difficult to integrate lower level and higher level objectives.

In another prior art approach (“customer-centric promotion allocation”), predefined customer segments are given the promotion(s) that are best in terms of a criterion specified by the marketing professional. As with promotion-centric segmentation, this approach only allows optimization of the criterion used for customer segmentation, and does not address the difficulty with integrating lower level and higher level objectives.

In yet another prior art approach (“scoring”), every customer is given a score with respect to a number of metrics for every promotion, and promotions are allocated to customers based on rules expressed in terms of their scores. Typically, the score for a customer is based on how closely that customer's behavior mirrors another customer's behavior, making the scores inherently unreliable. In addition, a single customer may have many different scores, depending on factors such as the metrics being considered or the type of product being offered, making this approach computer resource intensive. In general, it is difficult to use the scoring approach to optimize the design of an advertising campaign.

In another prior art approach (“universal segmentation”), customers are segmented independent of the promotions being considered. For every segment and every promotion, metrics are estimated for use in the optimization of the advertising campaign. The disadvantage to this approach is that, because customers and promotions are considered independently, it does not allow subtle relationships between customers and promotions to be exploited in order to more accurately achieve the higher level objectives.

In summary, prior art approaches attempting to integrate decisions at the promotion and segment level with higher level business objectives and constraints are problematic. If the marketing professional wants to segment customers based on their predicted reactions to a specific promotion, the number of promotions and segments becomes too large to make optimizing decisions. If the marketing professional attempts to simplify the process at the promotion and segment level as described above, then optimization only occurs for the criterion used for customer segmentation, and the effectiveness of the advertising campaign is likely reduced.

Accordingly, what is needed is a method and/or system that can reduce the complexity associated with designing an effective advertising campaign without losing the advantages provided by segmenting customers. Specifically, what is needed is a method and/or system that can reduce the number of input parameters and the complexity of the optimization task when customer segmentation is used. The present invention provides a novel solution to the above needs.

### DISCLOSURE OF THE INVENTION

The present invention provides a method and system thereof that can reduce the number of input parameters and the complexity of the optimization task when customer segmentation is used to design an advertising campaign. Accordingly, the present invention provides a method and system thereof that can reduce the complexity associated with designing an effective advertising campaign without losing the advantages provided by segmenting customers.

In the present embodiment of the present invention, each customer in a test group of customers is segmented into one of a plurality of segments for each promotion in a plurality of promotions. In the present embodiment, segmentation of customers is accomplished using a segmentation method such as CART (Classification and Regression Tree), k-means, k-harmonic means, clustering, or other methods known in the art.

Accordingly, for each promotion, there is a corresponding set of segments, each segment representing a first respective group of customers having a certain response to the promotion. The customers are then separated into a plurality of meta-segments, wherein each meta-segment represents a second respective group of customers having a certain response to all of the promotions in the plurality of promotions. In one embodiment, a vector representing a combination of a segment and promotion is associated with each customer and used for separating customers into meta-segments.

In another embodiment, a certain number of meta-segments is selected based on customer demographics, computational resources, or other factors. For example, the number of meta-segments can be chosen so as to maximize the number of customers that can be represented with a given number of meta-segments. The number of meta-segments can also be chosen so as to include those customers that might generate the most revenue or that might have a higher probability of accepting a particular promotion. In general, the meta-segments are chosen to represent a relevant subset of all customers.

In yet another embodiment, an algorithm is executed to determine how many customers in each meta-segment should receive a particular promotion.

Meta-segmentation in accordance with the present invention provides a flexible and manageable approach for optimizing the design of an effective advertising campaign. The present invention allows marketing professionals to consider customers based on their predicted reactions to a particular promotion (that is, based on their segment), without the encumbrance of evaluating each combination of promotion and segment. The present invention thus reduces the number of input parameters that need to be considered, which reduces the problem of optimizing the advertising campaign and allows the optimization to be completed faster, while still maintaining a desirable level of detail.

The use of a two stage segmentation process (segmentation and meta-segmentation) allows data gathered for the segments in the first segmentation to infer data for the second stage segmentation. This improves the speed and reliability of statistical estimation of data for the meta-segmentation since the total number of segments in the first stage segmentation is normally small in comparison to the second stage of segmentation (meta-segmentation).

Another advantage provided by the present invention is that it allows the use of efficient and flexible methods to optimize global and local objectives and constraints when determining actions to be performed on members of the segments. Creation and use of promotion-specific segmentation of tractable size allows for good optimization results.

These and other objects and advantages of the present invention will become obvious to those of ordinary skill in the art after having read the following detailed description of the preferred embodiments that are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary computer system upon which embodiments of the present invention may be practiced.

FIG. 2 is a data flow diagram showing a method for segmenting customers by promotion in accordance with one embodiment of the present invention.

FIG. 3 is a data flow diagram exemplifying the segmentation of customers by promotion in accordance with one embodiment of the present invention.

FIG. 4 is a flowchart of the steps in a process for segmenting customers by promotion in accordance with one embodiment of the present invention.

FIG. 5 is a flowchart of the steps in a process for segmenting a customer in accordance with one embodiment of the present invention.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, fragments, pixels, or the like.

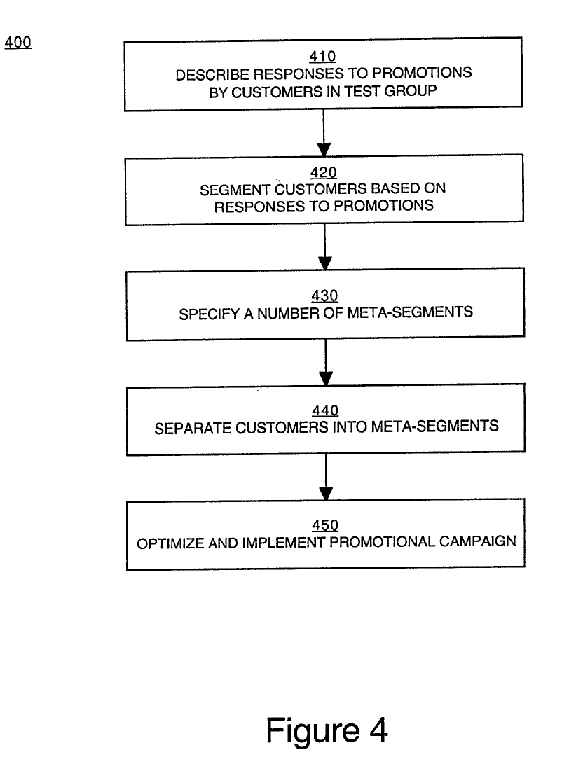

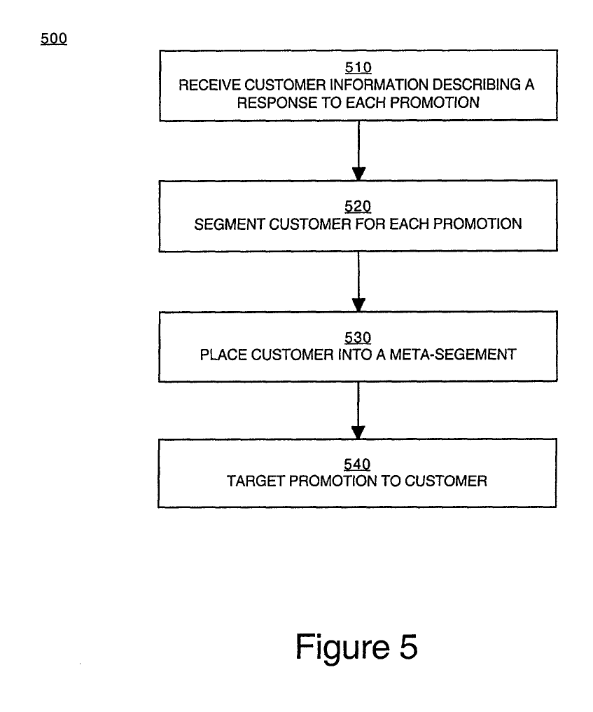

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “segmenting,” “separating,” “specifying,” “executing,” “associating,” “receiving,” “placing,” “selecting,” “determining,” “executing,” “recording” or the like, refer to actions and processes (e.g., processes 400 and 500 of FIGS. 4 and 5, respectively) of a computer system or similar electronic computing device. The computer system or similar electronic computing device manipulates and transforms data represented as physical (electronic) quantities within the computer system memories, registers or other such information storage, transmission or display devices. The present invention is well suited to the use of other computer systems.

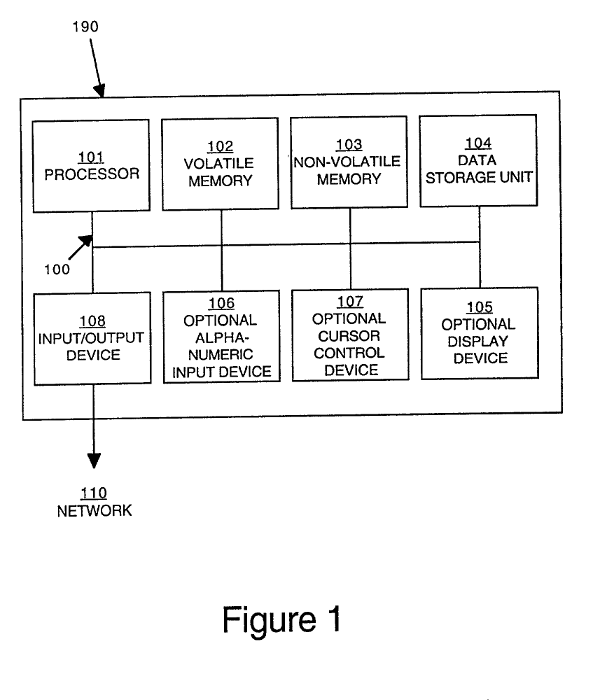

Refer now to FIG. 1, which illustrates an exemplary computer system 190 upon which embodiments of the present invention may be practiced. In general, computer system 190 comprises bus 100 for communicating information, processor 101 coupled with bus 100 for processing information and instructions, random access (volatile) memory (RAM) 102 coupled with bus 100 for storing information and instructions for processor 101, read-only (nonvolatile) memory (ROM) 103 coupled with bus 100 for storing static information and instructions for processor 101, data storage device 104 such as a magnetic or optical disk and disk drive coupled with bus 100 for storing information and instructions, an optional user output device such as display device 105 coupled to bus 100 for displaying information to the computer user, an optional user input device such as alphanumeric input device 106 including alphanumeric and function keys coupled to bus 100 for communicating information and command selections to processor 101, and an optional user input device such as cursor control device 107 coupled to bus 100 for communicating user input information and command selections to processor 101.

With reference still to FIG. 1, display device 105 utilized with computer system 190 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

Computer system 190 also includes an input/output device 108, which is coupled to bus 100 for providing a physical communication link between computer system 190 and a network 110 (not shown). As such, input/output device 108 enables central processor unit 101 to communicate with other electronic systems coupled to the network. It should be appreciated that within the present embodiment, input/output device 108 provides the functionality to transmit and receive information over a wired as well as a wireless communication interface (such as an IEEE 802.11b interface). It should be further appreciated that the present embodiment of input/output device 108 is well suited to be implemented in a wide variety of ways. For example, input/output device 108 could be implemented as a modem.

The network 110 may represent a portion of a communication network located within a firewall of an organization or corporation (an “Intranet”), or network 110 may represent a portion of the World Wide Web or Internet. The mechanisms for coupling computer system 190 in the Internet (or Intranet) are well known in the art. In the present embodiment, standard Internet protocols like IP (Internet Protocol), TCP (Transmission Control Protocol), HTTP (HyperText Transfer Protocol) and SSL (Secure Sockets Layer) are used to transport data between clients and servers, in either direction. However, the coupling of computer system 190 in a network 110 can be accomplished over any network protocol that supports a network connection, including NetBIOS, IPX (Internet Packet Exchange), and LU6.2, and link layers protocols such as Ethernet, token ring, and ATM (Asynchronous Transfer Mode). Computer system 190 may also be coupled to network 110 via an input/output port (e.g., serial ports) or via a wireless connection (e.g., according to IEEE 802.11b).

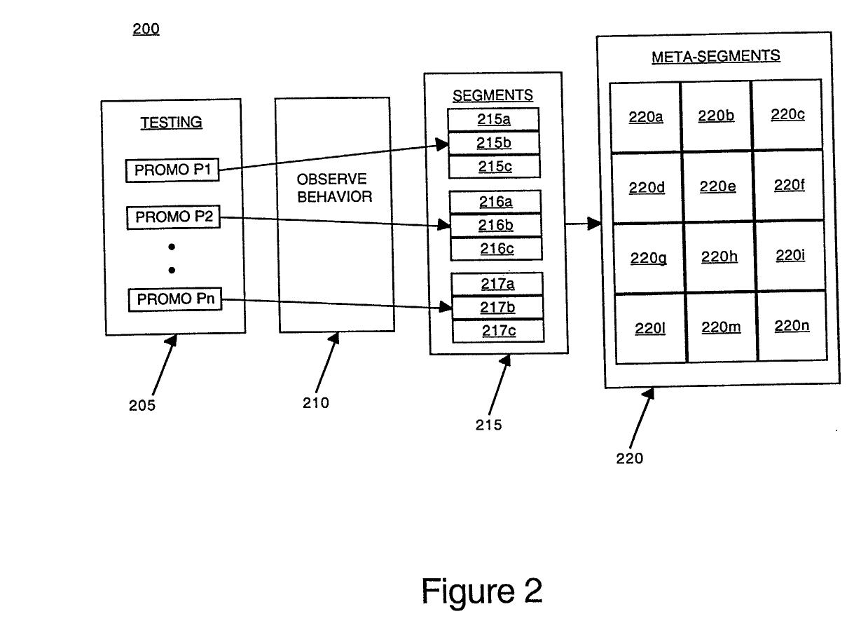

FIG. 2 is a diagram 200 showing a process for segmenting customers by promotion in accordance with one embodiment of the present invention. The method of diagram 200 is further described in conjunction with FIGS. 4 and 5, below.

In the testing block 205 of diagram 200, in the present embodiment, various promotions (e.g., “promo” P1, P2, . . . , Pn) are presented to a test group of customers. In general, each promotion P1, P2, . . . , Pn is presented to each customer in the test group. However, it appreciated that other techniques known in the art may be used to elicit responses from customers to a variety of promotions. In addition, information characterizing each customer (e.g., customer demographics such as the customer's level of education, income, address, hobbies and interests, recent purchases, etc.) is also gathered using any of the various known techniques.

In the observe behavior block 210, the response of each customer to each promotion P1, P2, . . . , Pn is measured and recorded, using techniques known in the art. Generally, customer responses can be used to determine a measure of the probability of acceptance by each customer to each promotion.

In the segmentation block 215, segmentation methods are used to segment (classify) the customer information received from the testing block 205 and the observe behavior block 210. Commonly used segmentation methods include CART (Classification and Regression Tree), k-means, k-harmonic means, and clustering. However, it is appreciated that other segmentation methods known in the art may be used in accordance with the present invention. In fact, the present invention is independent of the segmentation method used.

Each of the segments in segmentation block 215 represents a respective group of customers that share a certain response to each of the promotions P1, P2, . . . , Pn. That is, for example, customers in (or represented by) segment 215a share a common response to promotion P1, customers in (or represented by) segment 215b share a different but common response to promotion P1, and so on. Similarly, customers in (or represented by) segment 216a share a common response to promotion P2, and customers in (or represented by) segment 217a share a common response to promotion Pn. It is appreciated that some variability in the responses described by a segment may be allowed. It is also appreciated that any number of segments may be generated to represent customers.

It is understood that segments 215a, 216a, and 217a, for example, may each represent a different group of customers. That is, for example, two customers may share a certain response to promotion P1 but have a different response to promotion P2, and so would be in the same segment for promotion P1 and in different segments for promotion P2.

In accordance with the present invention, in the meta-segmentation block 220, an additional segmentation step is performed to separate the customers into groups (meta-segments 220a-n) that share a certain response to all of the promotions P1, P2, . . . , Pn. That is, the customers in meta-segment 220a share a common response to all of the promotions P1, P2, . . . , Pn, while the customers in a segment (e.g., 215a) share a common response only to a single promotion (e.g., P1). It is appreciated that some variability in the responses described by a meta-segment may be allowed.

There may be any number of meta-segments 220a-n. In one embodiment, the number of meta-segments 220a-n is selected by balancing factors such as computational resources versus customer demographics.

For a specified number of meta-segments, the meta-segments 220a-n can be selected to maximize (or minimize) some aspect of the customer demographics or to optimize some aspect of the advertising campaign. For example, if customers would be ideally represented by 11,000 meta-segments but only 10,000 meta-segments are permissible, the 10,000 meta-segments can be chosen so as to represent the maximum number of customers. The meta-segments can also be selected to encompass those customers that might generate the most revenue, are more likely to accept promotions, etc.

In one embodiment, customers that fall outside of the permissible number of meta-segments, or customers that are unique enough that they are not captured by a meta-segment or are members of a meta-segment that is small in number, are included in another meta-segment that most closely represents them. However, it is expected that, based on observed customer behavior patterns, most customers will fall within a small number of meta-segments, and that a manageable number of meta-segments will encompass a large percentage of the customer base.

The use of a two stage segmentation process (segmentation and meta-segmentation) allows data gathered for the segments in the first segmentation to infer data for the second stage segmentation. This improves the speed and reliability of statistical estimation of data for the meta-segmentation since the total number of segments in the first stage segmentation is normally small in comparison to the second stage of segmentation (meta-segmentation).

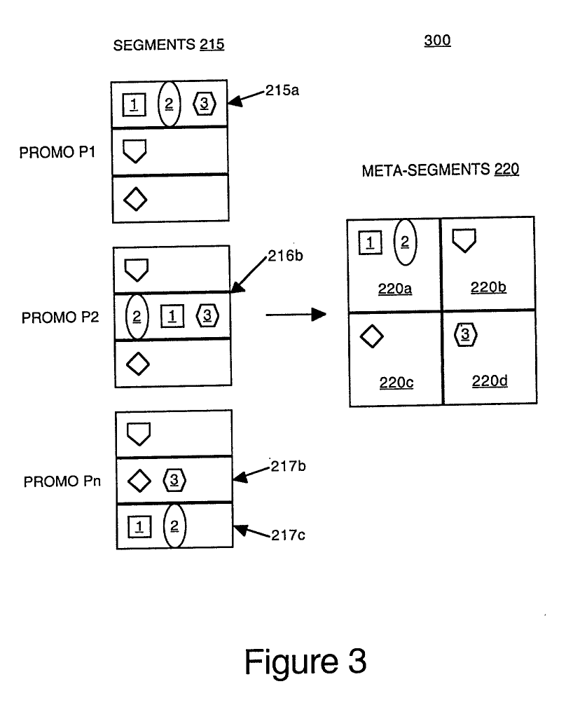

FIG. 3 is a diagram 300 exemplifying the segmentation of customers 1, 2 and 3 by promotion P1, P2 and Pn in accordance with one embodiment of the present invention. Customers 1-3 share a common response to promotions P1 and P2, and are therefore placed in the same segments 215a and 216b, respectively, using one of the known segmentation methods. Customers 1 and 2 share the same response to promotion Pn and are placed in segment 217c, while customer 3 has a different response to promotion Pn and is placed in segment 217b.

In accordance with the present invention, customers 1 and 2 are placed in the same meta-segment 220a because they share a common response to all promotions P1, P2 and Pn. That is, the combination of responses to promotions P1, P2 and Pn is the same for customers 1 and 2. Customer 3 is placed in a different meta-segment 220d. Other customers are placed into other meta-segments (e.g., 220b and 220c) depending on the type of responses (e.g., the combination of responses) they have to the various promotions. If there is a desire to reduce the number of meta-segments, customers represented by meta-segments 220b and 220c, for example, can be placed into another meta-segment that may closely represent them is some manner.

FIG. 4 is a flowchart of the steps in a process 400 for segmenting customers by promotion in accordance with one embodiment of the present invention. In this embodiment, process 400 is implemented by computer system 190 (FIG. 1) as computer-readable program instructions stored in a memory unit (e.g., ROM 103, RAM 102 or data storage device 104 of FIG. 1) and executed by a processor (e.g., processor 101 of FIG. 1). However, it is appreciated that some aspects of process 400 may be implemented on one computer system, with other aspects of process 400 performed on another. For example, segmentation of customers (as described for the segmentation block 215 of FIG. 2) may be performed on one computer system, while separation of customers into meta-segments 220a-n (FIG. 2) may be performed on another. It is further appreciated that the steps in process 400 can be performed in an order different from that described.

In step 410 of FIG. 4, in one embodiment, customer responses to each of a variety of different promotions (e.g., P1, P2, . . . , Pn of FIG. 2) are measured and recorded using a known technique. In step 420 of the present embodiment, based on their responses to the promotions P1, P2, . . . , Pn, the customers are segmented into different segments (e.g., segments 215 of FIG. 2) for each promotion using a known segmentation method. For each promotion, there is a corresponding set of segments; each segment in the set of segments for a promotion represents customers having a certain (e.g., shared) response to the respective promotion, as described above with respect to FIGS. 2 and 3.

In step 430 of FIG. 4, in one embodiment, a number of meta-segments is specified. The number of meta-segments specified can depend on a number of factors, including computational resources available, the granularity (discreteness) that is desired for grouping customers, the customer demographics, as well as other factors. It is understood that customers can be first grouped into meta-segments (as described by step 440 below), and then the number of meta-segments can be specified.

In step 440, in accordance with the present invention, the customers are separated into meta-segments (e.g., meta-segments 220 of FIG. 2), in which each meta-segment represents a group of customers that have the same response to all of the promotions being considered.

In one embodiment, a vector representing a combination of segments and/or promotions is associated with each customer. That is, each customer can be associated with a vector describing the combination of segments he/she is represented by based on his/her response to each promotion. Customers associated with the same vector can then be grouped into the same meta-segment.

In step 450 of FIG. 4, the meta-segmentation information (e.g., meta-segments 220a-n) is used to design, optimize and implement a promotional (advertising) campaign. In one embodiment, an algorithm is executed to determine a number of customers in each meta-segment that is to receive a particular promotion. Promotions can be allocated to each meta-segment such that business objectives (e.g., maximize revenues, minimize costs, and/or maximize acceptance probability) are achieved while budget constraints and business rules are satisfied. One example of a method for allocating promotions is described in the co-pending patent application entitled “Method and System of Determining Differential Promotion Allocations,” Attorney Docket No. HP-321, assigned to the assignee of the present application and herein incorporated by reference.

By working with meta-segments instead of each possible combination of segments and promotions, the complexity of the decisions that need to be made while designing and optimizing the promotional campaign is reduced. Furthermore, because the number of input parameters that need to be considered is reduced, the computational effort is also reduced. The present invention also allows the use of efficient and flexible methods to optimize global and local objectives and constraints when determining actions to be performed on members of the segments. Creation and use of promotion-specific segmentation of tractable size allows for good optimization results using those methods.

FIG. 5 is a flowchart of the steps in a process 500 for segmenting a customer in accordance with one embodiment of the present invention. In this embodiment, process 500 is implemented by computer system 190 (FIG. 1) as computer-readable program instructions stored in a memory unit (e.g., ROM 103, RAM 102 or data storage device 104 of FIG. 1) and executed by a processor (e.g., processor 101 of FIG. 1). However, it is appreciated that some aspects of process 500 may be implemented on one computer system, with other aspects of process 500 performed on another. For example, segmentation of customers (as described for the segmentation block 215 of FIG. 2) may be performed on one computer system, while separation of customers into meta-segments 220a-n (FIG. 2) may be performed on another.

In step 510 of FIG. 5, customer information describing the customer's response to each promotion being considered (e.g., P1, P2, . . . , Pn of FIG. 2) is received. Information describing the customer (e.g., the customer's characteristics or demographics) may also be received.

In step 520 of FIG. 5, in one embodiment, the customer information is used with a known segmentation method to segment the customer into a segment (e.g., segments 215 of FIG. 2) for each of the promotions. That is, the customer is segmented into a plurality of segments, one segment for each promotion.

In step 530 of FIG. 5, in accordance with the present embodiment of the present invention, the customer is placed into a meta-segment (e.g., meta-segments 220 of FIG. 2). In the present embodiment, the customer is placed into a single meta-segment based on his/her responses to all of the promotions being considered.

In step 540 of FIG. 5, one or more promotions are targeted to the customer, depending on the meta-segment in which the customer is located, as well as other factors considered in the design of the advertising campaign.

In summary, embodiments of the present invention provide a method and system thereof for reducing the number of input parameters and the complexity of the optimization task when customer segmentation is used to design an advertising campaign. Accordingly, the present invention provides a method and system thereof that can reduce the complexity associated with designing an effective advertising campaign without losing the advantages provided by segmenting customers.

The preferred embodiment of the present invention, global campaign optimization with promotion-specific customer segmentation, is thus described. While the present invention has been described in particular embodiments, it should be appreciated that the present invention should not be construed as limited by such embodiments, but rather construed according to the following claims.

What is claimed is:

1. A method for segmenting customers by promotion, said method comprising the steps of:
a) segmenting each customer in a plurality of customers into a segment in a plurality of segments for each promotion in a plurality of promotions, such that for a promotion there is a corresponding set of segments, wherein each segment in said set of segments represents a first respective group of customers having a certain response to said promotion; and
b) separating said plurality of customers into a plurality of meta-segments, wherein each meta-segment in said plurality of meta-segments represents a second respective group of customers having a certain response to all promotions in said plurality of promotions.

2. The method as recited in claim 1 comprising the step of:
specifying a number of meta-segments based on customer demographics, wherein said customer demographics define characteristics of said plurality of customers.

3. The method as recited in claim 2 wherein said number of meta-segments is specified such that the maximum number of customers are represented by said meta-segments.

4. The method as recited in claim 2 further comprising the step of:
executing an algorithm for determining a number of customers in each meta-segment to receive a particular promotion.

5. The method as recited in claim 1 wherein said segmenting of said step a) is accomplished using a segmentation method selected from the group consisting of CART (Classification and Regression Tree), k-means, k-harmonic means and clustering.

6. The method as recited in claim 1 wherein said step b) comprises the step of:
associating with each customer a vector representing a combination of a segment and a promotion.

7. A method for segmenting customers by promotion, said method comprising the steps of:
a) receiving information for a customer describing said customer's response to each promotion in a plurality of promotions;
b) segmenting said customer into a segment for said each promotion, wherein for each promotion there is a corresponding set of segments, wherein each segment in said set of segments represents a first respective group of customers having a certain response to said promotion; and
c) placing said customer into a meta-segment in a plurality of meta-segments, wherein said meta-segment represents a second respective group of customers having a certain response to all promotions in said plurality of promotions.

8. The method as recited in claim 7 further comprising the step of:
selecting a subset of said meta-segments based on customer demographics, wherein said subset is limited to a specified number of meta-segments and wherein said customer demographics define characteristics of said plurality of customers.

9. The method as recited in claim 8 wherein said subset of meta-segments is selected such that said specified number of meta-segments represents the maximum number of customers.

10. The method as recited in claim 8 further comprising the step of:
determining a particular promotion to be provided to said customer.

11. The method as recited in claim 7 wherein said segmenting of said step b) is accomplished using a segmentation method selected from the group consisting of CART (Classification and Regression Tree), k-means, k-harmonic means and clustering.

12. The method as recited in claim 7 wherein said step c) comprises the step of:
associating with said customer a vector representing a combination of a segment and a promotion.

13. A method for segmenting customers by promotion, said method comprising the steps of:
a) recording information characterizing a response from each customer in a plurality of customers to each promotion in a plurality of promotions; and
b) separating said plurality of customers into a plurality of meta-segments, wherein each meta-segment in said plurality of meta-segments represents a respective group of customers having a certain response to all promotions in said plurality of promotions.

14. The method as recited in claim 13 wherein said step a) further comprises the step of:
a1) segmenting each customer in said plurality of customers into a segment in a plurality of segments for each promotion in said plurality of promotions, such that for a promotion there is a corresponding set of segments, wherein each segment in said set of segments represents a respective group of customers having a certain response to said promotion.

15. The method as recited in claim 14 wherein said segmenting of said step a1) is accomplished using a segmentation method selected from the group consisting of CART (Classification and Regression Tree), k-means, k-harmonic means and clustering.

16. The method as recited in claim 14 wherein said step al) further comprises the step of:
associating with each customer a vector representing a combination of a segment and a promotion.

17. The method as recited in claim 14 further comprising the step of:
specifying a number of meta-segments based on customer demographics, wherein said customer demographics define characteristics of said plurality of customers.

18. The method as recited in claim 17 wherein said number of meta-segments is specified such that the maximum number of customers are represented by said meta-segments.

19. The method as recited in claim 17 further comprising the step of:
executing an algorithm for determining a number of customers in each meta-segment to receive a particular promotion.
